(19) United States
(12) Patent Application Publication
(10) Pub. No.: US 2022/0202012 A1
(43) Pub. Date: Jun. 30, 2022

(54) SPROUT INHIBITOR FOR POTATO AND METHOD OF USE THEREOF

(71) Applicant: UPL Limited, Mumbai (IN)

(72) Inventor: Tony Kievit, Breda (NL)

(21) Appl. No.: 17/601,791

(22) PCT Filed: Apr. 13, 2020
(86) PCT No.: PCT/IB2020/053465

§ 371 Date: Oct. 6, 2021

(30) Foreign Application Priority Data
Apr. 13, 2019 (IN) 201921014954

(51) Int. Cl. A01N 43/50; A01P 21/00; A23B 7/154; A01G 22/25; A01N 25/02

(52) U.S. Cl. CPC A01N 43/50; A01P 21/00; A01N 25/02; A01G 22/25; A23B 7/154

(57) ABSTRACT

The present invention relates to a sprout inhibitor for potato and a method of inhibiting sprout formation in tubers. More particularly, the present invention relates to acetolactate synthase (ALS) herbicide as tuber sprout inhibitor. The present invention further provides compositions comprising acetolactate synthase (ALS) as anti-sprouting agent.

### FIELD OF INVENTION

The present invention relates to a sprout inhibitor and a method of inhibiting sprout formation in tubers. More particularly, the present invention relates to the use of acetolactate synthase (ALS) herbicides as tuber sprout inhibitors. The present invention further provides compositions comprising acetolactate synthase (ALS) as anti-sprouting agents.

### BACKGROUND OF THE INVENTION

Potato is a highly nutritious, mild flavoured, easy to blend food that has possibilities for “building in” desired nutrients. Potatoes are the vegetable crop grown locally and harvested once a year thus they have to be stored to ensure supplies until the next harvest. Sprouting, weight loss, rotting and low temperature sweetening are the major problems during storage.

The sprouting of potatoes is promoted due to the variation of conditions including the ascent of temperature during the distribution process which includes the packing of potatoes from storage house in distribution containers such as cardboard, plastic bag and the like for transporting the packages to distributors, sellers, and the consumers.

Methods of storage have been designed to prolong the dormant period and to retard or inhibit undesirable chemical changes in potatoes. Such methods involve classical low temperature storage and the use of sprouting inhibiting chemicals such as maleic hydroxide, α-naphthalene acetic acid, isopropyl N-(3chlorophenyl) carbonate (CIPC) and 1, 2, 4, 5 tetra chloro-3 -nitro benzene. Even though untreated potatoes are stored at a cool temperature, sprouting does begin to occur after a month or more of storage. Further, treatment of potatoes with the chemicals produces various undesirable side effects and these methods are restricted because of the problem of residual agricultural chemicals or insecurity for safety. In fact, the use of mechanical refrigeration for low temperature storage is limited by economics. The low-temperature storage induces sweetening in potatoes due to increase in high reducing and total sugars thereby making them unsuitable for further use. Thus, currently applied methods for long term storage are not adequate to control the deterioration as around 50% of the product is lost in a few months of storage.

The storage of tubers such as potatoes is preferably done at a temperature between 2 and 10° C. However, at this temperature the potato converts starch into sugar and stores the sugar in the potato leading to a sweeter taste.

The cure to the build-up of sugar in the potato is to store the potatoes at a higher temperature, preferably around 15° C. a couple of weeks before the potatoes are put on the market. In this period the sugar level within the potato will drop, but the potato will start to produce sprouts or germs. Along with sprout formation, the potato will start to produce toxic glycoalkaloids. These molecules are not destroyed during cooking. This process makes the potato unsellable.

Some potato storages are not equipped with a climate control unit and the temperature within the storage depends on weather conditions. If the temperature within the warehouse can't be kept low enough, potatoes will start to sprout. Consequently, other treatment methods are required, especially for long term storage.

As described above synthetic sprout inhibitor like 3-chlorophenylisopropylcarbamate (CIPC) also known as chlorpropham, treatment leaves behind a film of CIPC residue on the treated tubers. This residue makes the treated products unfit to be marketed as fresh produce. In this market segment practically no residue level is tolerated (max. 4-10 ppm).

Maleic hydrazide is another growth regulator that inhibits sprout formation. Maleic hydrazide is applied on the foliage of the crop on the field before harvesting; the uptake of it is depending on field conditions. The maleic hydrazide is taken up by the crop, like potato, and is stored inside the tuber for a relatively long time (preventive mode of action). The maximum residue level is 50 ppm. Consequently the treatment with maleic hydrazide is not acceptable for products destined for the fresh produce market segment.

With the higher degree of customer awareness about pesticidal residues on food products and the higher demand for biological produced vegetables, there is a demand for effective alternatives to synthetic sprout inhibitors, such as CIPC and maleic hydrazide. To find acceptance in the bio-market segment, an alternative treatment is preferably based on a renewable resource, leaving no residue. Hence, there is a need in the art to provide further alternative treatment methods for the storage of tubers, especially for potato tubers.

There is much interest in the replacement of known sprout inhibitors. Thus, the potato growing industry will benefit from new economical and effective alternatives. The present invention aims to provide a sprout inhibitor that inhibits sprout formation particularly in potato and a method for the storage of tubers, in particular potato tubers. In particular, the invention aims to provide treated tubers acceptable to the fresh produce market. Suitable compositions will also be provided. The present invention relates to a sprout inhibitor for inhibiting the growth of potato tuber. More particularly the invention relates to acetolactate synthase compounds as novel sprout inhibitor. The present invention also provides a method of controlling sprout formation particularly in potatoes and a method of inhibiting tuber sprouting that exhibit substantially equal or greater effectiveness than the compounds described in the prior art.

### OBJECT OF THE INVENTION

It is an object of this invention to provide a new sprout inhibitor for tubers. Another object of this invention is to provide an acetolactate synthase herbicide (ALS inhibitor) as sprout inhibitor for tubers.

Another object of the invention is the use of ALS inhibitor for the suppression of sprouting during tuber preservation/storage.

Another object of this invention is to provide a composition comprising a ALS herbicide as sprout inhibitor.

In an object the present invention provides a method for inhibiting tuber sprouting without necrosis or softening of the tuber.

It is a further object to provide a method for inhibiting the sprouting of tubers under storage using herbicide.

Yet another object of the invention is to provide a method for inhibiting tuber sprouting which also prevents or controls fungal growth upon the tubers, thereby reducing postharvest decay losses.

Another object of this invention is to provide a acetolactate synthase herbicide as sprout inhibitor which can effectively prevent mold growth, reduce rot disease incidence in tubers.

### SUMMARY OF THE INVENTION

In an aspect the present invention provides a sprout inhibitor for tubers.

In another aspect the present provides the use of an acetolactate synthase inhibitor herbicide as a sprout inhibitor.

In another aspect the present provides the use of an imidazolinone compound as a sprout inhibitor.

In another aspect the present provides the use of an imidazolinone compound selected from the group comprising imazamethabenz, imazamox, imazapic, imazaquin, imazethapyr, imazapyr or combinations thereof as a sprout inhibitor. In another aspect the present provides the use of imazamox as a sprout inhibitor. In yet another aspect the present invention provides a composition for sprout inhibition in tubers, said composition comprising an acetolactate synthase herbicide.

In yet another aspect the present invention provides a composition for sprout inhibition in tubers, said composition comprising an imidazolinone compound.

In yet another aspect the present invention provides a composition for sprout inhibition in tubers, said composition comprising imazamox.

In yet another aspect the present invention provides a composition for sprout inhibition in tubers, said composition comprising an acetolactate synthase herbicide; and one or more agrochemically acceptable carrier.

In a further aspect, the invention provides a composition for sprout inhibition in tubers, said composition comprising an acetolactate synthase inhibitor herbicide. In another aspect the present invention provides a composition for sprout inhibition in tubers during its storage, said composition comprising an acetolactate synthase inhibitor herbicide.

In another aspect the present invention provides a composition for sprout inhibition in tubers, said composition comprising an acetolactate synthase inhibitor herbicide.

Another object of the present invention is to provide a method for inhibiting tuber sprouting without necrosis or softening of the tuber wherein said method comprises applying an effective amount of an acetolactate synthase inhibitor herbicide.

It is a further object of this invention to provide a method for inhibiting the sprouting of tubers under storage using an acetolactate synthase inhibitor herbicide formulation.

In another aspect the present provides the use of an acetolactate synthase inhibitor herbicide as a sprout inhibitor.

In another aspect the present provides use of a composition comprising an acetolactate synthase inhibitor herbicide as a sprout removal agent.

### DETAILED DESCRIPTION OF THE INVENTION

The following description is provided to assist in a comprehensive understanding of exemplary embodiments of the invention. It includes various specific details to assist in that understanding but these are to be regarded as merely exemplary. Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for limiting the scope of the invention as defined by the appended claims and their equivalents.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

As used herein, the term “tuber” is inclusive of “potato tuber.” The term “potato tuber” refers to the underground storage organ of the potato plant (Solanum tuberosum). The potato tuber is a modified stem and includes buds that can sprout and form new potato plants. The term “(potato) tubers” refers to both tubers generally and to potato tubers of various varieties.

By the term “fogging” as used in the present invention, is meant the vaporization of pesticides in the form of fog for distribution and application of the pesticide. Fogging is carried out by a fogging machine or fogair sprayer. This type of equipment is known to a person skilled in the art. A fogging machine may consist of a fuel tank, formulation tank, pump, fogging nozzle, fogging coil, water pump and controls.

The present invention is at least partly predicated on the unexpected finding by the present inventors and supported by experimental evidence as disclosed herein. The acetolactate synthase (ALS) inhibiting herbicides, also called acetohydroxyacid synthase (AHAS), have a broad spectrum of selectivity and are used at low rates as soil-applied or postemergence treatments in many cropping systems, trees and vines, roadsides, range and pasture, turf, and vegetation management.

As used herein the term “inhibit sprouting of tuber” refers to either the number, and/or the weight, of buds and sprouts/stems which are growing from a defined number of tubers when they are contacted with a composition in accordance with the present invention is less than the number, and/or the weight, of the sprouts growing from the same number of control (potato) tubers that were not contacted with a composition in accordance with the present invention; and/or the average rate of growth of buds, stems growing from a defined number of potato tubers when contacted with a composition in accordance with the present invention is less than the average rate of growth of buds, stems growing from the same number of control (potato) tubers that were not contacted with the composition. The concept of inhibition as discussed herein means when control tubers show activity being inhibited in tubers contacted with the composition in accordance with the invention, as understood by those skilled in this field.

The present invention provides an effective anti-sprouting treatment of potatoes. More particularly, the present invention conceals using a herbicide, acetolactate synthase inhibitor, as sprout inhibitor and a method for inhibiting sprouting of potato tuber.

Surprisingly, it has been found by the present inventors that acetolactate synthase herbicide can be advantageously used to inhibit tuber sprouting, fresh weight loss, rotting, and fungal growth by exposure of the tubers thereto. These ALS inhibitors are effective to inhibit sprouting of tuber particularly potato and exhibit substantially improved effect overcoming the drawbacks associated in the prior art. Acetolactate synthase inhibitor herbicide can be used, if desired, in the same manner as conventional sprout inhibitors used for potatoes.

In an aspect the present invention provides acetolactate synthase inhibitor as sprout inhibitor.

In an aspect the present invention provides the use of a acetolactate synthase inhibitor as sprout inhibitor.

In another aspect the present invention provides the use of acetolactate synthase inhibitor for effectively inhibiting tuber sprouting particularly in potatoes.

In an embodiment, the present invention provides the use of acetolactate synthase inhibitor as sprout inhibitor during the storage of potatoes.

In another embodiment, the acetolactate synthase inhibitor herbicide is selected from imidazolinones, pyrimidinylthiobenzoates, sulfonylamino carbonyl triazolinones, ureas preferably sulfonylureas, pyrazole, triazolones and triazolopyrimidines.

In another embodiment, the acetolactate synthase inhibitor herbicide is imidazolinone compound.

The imidazolinone herbicides or specific imidazolinone herbicide species as referred in this application include the compounds as mentioned below, as well as their a) salts, e.g. salts of alkaline or earth alkaline metals or ammonium or organoammonium salts, for instance, sodium, potassium, ammonium, preferably isopropyl ammonium etc.; b) respective isomers, e.g. stereo isomers such as the respective enantiomers, in particular the respective R-or S-enantiomers (including salts, ester, amides), c) respective esters, e.g. carboxylic acid C1-C8-(branched or non-branched) alkyl esters, such as methyl esters, ethyl esters, iso propyl esters, d) respective amides, e.g. carboxylic acid amides or carboxylic acid C1-C8-(branched or non-branched) mono- or dialkyi amides, such as dimethyl amides, diethyl amides, diisopropyl amides or e) any other derivative which contains the above imidazolinone structures as structural moiety.

In an embodiment imidazolinone compound is selected from the group comprising imazamethabenz, imazamox, imazapic, imazaquin, imazethapyr, imazapyr or combinations thereof.

In an embodiment, the imidazolinone compound is imazamox.

In an embodiment, the imidazolinone compound is imazapic.

In an embodiment, the imidazolinone compound is imazethapyr.

In an embodiment, the imidazolinone compound is imazapyr.

In an embodiment urea herbicide is selected from benzthiazuron, cumyluron, cycluron, chlorsulfuron, ethametsulfuron methyl, metsulfuron-methyl, nicosulfuron, rimsulfuron, thifensulfuron-methyl, tribenuron-methyl, triflusulfuron methyl, dichloralurea, diflufenzopyr, isonoruron, isouron, methabenzthiazuron, monisouron, noruron, anisuron, buturon, chlorbromuron, chloreturon, chlorotoluron, chloroxuron, daimuron, difenoxuron, dimefuron, diuron, fenuron, fluometuron, flothiuron, isoproturon, linuron, methiuron, methyldymron, metobenzuron, metobromuron, metoxuron, monolinuron, monuron, neburon, parafluron, phenobenzuron, siduron, tetrafluron, thidiazuron, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, buthiuron, ethidimuron, tebuthiuron, thiazafluron, thidiazuron and combinations thereof.

Example of pyrimidinylthiobenzoates include pyrithiobac.

In an embodiment pyrazole herbicide is selected from azimsulfuron, cyclopyranil, difenzoquat, halosulfuron, metazachlor, metazosulfuron, pyraclonil, pyrazosulfuron, pyroxasulfone, benzoylpyrazole include benzofenap, pyrasulfotole, pyrazolynate, pyrazoxyfen, tolpyralate, topramezone, phenylpyrazole include fluazolate, nipyraclofen, pinoxaden and pyraflufen.

In an embodiment, triazolone herbicides is selected from amicarbazone, bencarbazone, carfentrazone, flucarbazone, ipfencarbazone, propoxycarbazone, sulfentrazone and thiencarbazone.

In an embodiment triazolopyrimidine herbicide is selected from cloransulam, diclosulam, florasulam, flumetsulam, metosulam, penoxsulam and pyroxsulam.

In another embodiment, an ALS inhibitor include, but not limited to, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thiencarbazone, thiencarbazone-methyl thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, pyrithiobac, pyrithiobac-sodium salt, pyriminobac, pyriminobac-methyl, bispyribac, bispyribac sodium salt, pyribenzoxim, pyrimisulfan, pyriftalid, and triafamone.

Herbicides that inhibit acetolactate synthase (ALS), is also called acetohydroxyacid synthase (AHAS) include, four classes of herbicides: sulfonylureas, imidazolinones, triazolopyrimidines, and pyrimidinyl thiobenzoates.

Imazamox (5 -(methoxymethyl)-2-(4-methyl-5-oxo-4-propan-2-yl-1H-imidazol-2-yl)pyridine-3-carboxylic acid) is part of the imidazolinone chemical class. It is an active ingredient in different herbicide formulations, as this class of compounds inhibits the enzyme acetohydroxyacid synthase, which catalyzes key reactions in the biosynthesis of branched-chain amino acids (valine, isoleucine, leucine) and regulates the end products of these pathways. The structure of imazamox is shown as below.

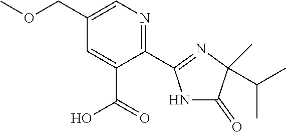 [SMILES: COCc1cnc(C2=NC(C)(C(C)C)C(=O)N2)c(C(=O)O)c1]

In an embodiment the ALS inhibitor herbicide is selected from imidazolinone compound.

In the preferred embodiment of the present invention, the imidazolinone compound comprises imazamox.

In an embodiment of the present invention the ALS inhibitor is imazamox.

In preferred embodiment, the present invention provides the use of imazamox as sprout inhibitor.

In an aspect the present invention provides a composition for tuber sprout inhibition, said composition comprising an acetolactate synthase (ALS) compound.

In another embodiment, the present invention provides a composition for inhibiting sprouting in potatoes, said composition comprising an acetolactate synthase inhibitor and at least one agrochemically acceptable excipient.

In an embodiment, the acetolactate synthase compound is selected from the group comprising imidazolinones, pyrimidinylthiobenzoates, sulfonylamino carbonyl triazolinones, ureas preferably sulfonylureas, pyrazole, triazolones, triazolopyrimidines or combinations thereof.

In an embodiment, the composition comprises imidazolinone compound as sprout inhibitor.

In an embodiment, the imidazolinone compound is selected from imazamethabenz, imazamox, imazapic, imazaquin, imazethapyr, imazapyr and combinations thereof.

In an embodiment, the composition comprising imazamox as sprout inhibitor.

The compositions of the present invention comprise ALS inhibitor alone or in mixture with another sprout inhibitor.

In an embodiment the composition comprises a mixture of ALS herbicide and at least one another sprout inhibitor.

In another embodiment, the present invention provides a composition comprising acetolactate synthase inhibitor herbicide and at least another sprout inhibitor.

In another embodiment, the present invention provides a composition comprising acetolactate synthase inhibitor herbicide and at least one another sprout inhibitor and at least one agrochemically acceptable excipient/carrier.

In another embodiment the another sprout inhibitor is selected from group consisting of chlorpropham (CIPC), dimethylnaphthalene (DMN), maleic hydrazide (MH), carvone, chlorophenoxy herbicides for example, 4-chloro-2-methyl phenoxyacetic acid (MCPA), 2-(4-chloro-2 methylphenoxy) propionic acid (MCPP), 2-(2,4-dichlorophenoxy) propionic acid (2,4-DP), diisopropylnaphthalene, aliphatic aldehydes and ketones, eugenol, benzothiazide, ethylene, aromatic acids for example anisic acid, coumaric acid, gallic acid), rape oil methyl ester, medium and long-chain alcohols, jasmonates, aromatic aldehydes for example benzaldehyde, salicaldehyde, cinnamaldehyde, hydrocinnamaldehyde, cuminaldehyde, thymol), monoterpenes for example cineole, fenchone, menthol), and essential oils for example mint oils.

In another embodiment another sprout inhibitor is chlorpropham.

In an embodiment the composition comprises acetolactate synthase inhibitor herbicide and chlorpropham.

In another embodiment another sprout inhibitor is maleic hydrazide.

In an embodiment the composition comprises acetolactate synthase inhibitor herbicide and maleic hydrazide.

In an embodiment the composition comprises acetolactate synthase inhibitor herbicide and at least one second sprout inhibitor selected from 4-chloro-2-methyl phenoxyacetic acid (MCPA), 2-(4-chloro-2 methylphenoxy) propionic acid (MCPP) and 2-(2,4-dichlorophenoxy) propionic acid.

In an embodiment the composition comprises at least one ALS inhibitor is in the form of a thermal fog.

In an embodiment the composition comprising at least one ALS inhibitor is in the form of an aerosol.

In an embodiment the composition comprising at least one ALS inhibitor is in the form of a liquid composition.

According to one preferred embodiment, the liquid composition is soluble concentrate (SL).

Preferably, the composition is an aqueous liquid composition.

Preferably, the liquid composition comprises imazamox as active ingredient.

Preferably, in the diluted liquid composition the concentration of imazamox active ingredient is from 50 to 400 ml/1000 kg.

Preferably, in the diluted liquid composition the concentration of imazamox active ingredient is from 50 to 250 ml/1000 kg.

The compositions of this invention also preferably comprise an agriculturally acceptable carrier/adjuvant.

Suitable agricultural adjuvants and/or carriers that are useful in preparing the compositions and which may be present in the compositions of the present invention, include, but not limited to, surfactant, fillers, crystallization inhibitors, viscosity modifiers, solvent, suspending agents, spray droplet modifiers, pigments, antioxidants, foaming agents, light-blocking agents, compatibilizing agents, antifoam agents, sequestering agents, neutralizing agents and buffers, corrosion inhibitors, dyes, odorants, spreading agents, penetration aids, emollients, lubricants, sticking agents, dispersing agents, thickening agents, freezing point depressants, antimicrobial agents, and the like.

Preferred adjuvant is selected from Ethoxy sorbitan monolaurate.

Typically, the composition comprise buffer for example sodium dihydrogen phosphate, potassium dihydrogen phosphate, ammonium hydroxide, ammonia solution, anti-freezing agent for example popylene glycol, preservative for example 1,2-benzisothiazolin-3-one and solvent for example water.

Other conventional inactive or inert ingredients can be incorporated into the present compositions. Such inert ingredients include but are not limited to: conventional sticking agents, dispersing agents such as methylcellulose, polyvinyl alcohol, lecithin, polymeric dispersants such as polyvinylpyrrolidone/vinyl acetate, emulsion stabilizers, surfactants, antifreeze compounds such as urea, dyes, colorants. By including suitable additives, the compositions can be better adapted for application as a spray on the crop like potato.

In the preferred embodiment of the present invention, the concentration of imazamox active ingredient in the diluted liquid composition is from about 100 to 250 grams/litre. Typically, the composition comprises imazamox as active ingredient in concentration of about 100 to 200 grams/litre, preferably 120 to 150 grams/litre.

The composition comprises aqueous liquid such as water.

The composition of the present invention can be combined with surfactant system.

Accordingly, the composition can further comprise one or more surfactant selected from anionic surfactant or non-ionic surfactant.

The surfactant is preferably present in the composition in an amount of 1 to 25 wt %, preferably 10-15 wt %, based on the weight of the composition.

The amount of ALS inhibitor that is applied to the potato tubers is preferably an amount effective to inhibit sprouting of the tubers. Sprouting inhibition can vary in the present invention from minimal to complete inhibition, including all variations there between.

In an embodiment the amount of ALS inhibitor that is effective to inhibit sprouting of the potato tubers depends on the potato cultivar being treated.

The methods of the present innovation are applicable to any tuber but are of greatest application commercially in the treatment of all potato varieties.

In an embodiment the methods of the present invention are applicable to any potato cultivar which include but not limited to, for example Russet Burbank, Ranger Russet, Solanum tuberosum, Umatilla Russet, Shepody, Norkotah Russet, Yukon Gold, Norchip, Gem Russet, Atlantic, Chipeta, Snowden, and Dark Red Norland.

The composition of present invention is applied to the potato preservation environment by the methods for example fumigating, spraying and the like.

In an embodiment the composition of present invention is applied at pre-storage and/or during the storage of potatoes.

Preferably, the treatment has no toxicity symptoms detected.

In preferred embodiment, the application is done by any of the method selected from spraying, wetting, dipping, drenching, showering, soaking, dampening, drizzling or dousing of the composition on the tubers.

In preferred embodiment the application is done by spraying.

The advantage is spraying application is faster and requires less energy than the fogging of the composition.

In a preferred embodiment the application of the composition comprising ALS inhibitor is repeated.

Preferably, the treatment is repeated within a period of from approximately 2 to 8 months from the first spray treatment.

In a preferred embodiment the composition comprising ALS inhibitor will be applied after the initial application in a subsequent dose of 20 ml to 300 ml /1000 kg, preferably of 50 to 250 ml/1000 kg. At this dose tubers will be treated completely.

In an alternative embodiment, the application is done by fogging.

In an embodiment the composition of present invention is applied by conveyor belt or fogging method.

In an embodiment the composition of the present invention is typically applied to potatoes to be stored using conveyor belt, which are well-known to the skilled person.

In an embodiment the composition of the present invention is typically applied to potatoes to be stored or during storage using hot fogging method, which are well-known to the skilled person.

In accordance with an aspect, the present invention provides a use of ALS inhibitor as sprout inhibitor for treating tubers in potato.

In preferred embodiment, the present invention provides a use of imazamox as sprout inhibitor for treating tubers in potato, wherein imazamox is mixed with a carrier to form a diluted liquid composition comprising imazamox, which is applied as a spray onto potatoes, wherein in the diluted liquid composition the concentration of the imazamox active ingredient applied is from 5 to 50 grams/1000 kg.

In practice the present invention includes any application of ALS inhibitor to tubers, and particularly includes application to potato tubers in the field before the potatoes are harvested, and/or application after the potatoes are harvested or before they are stored, during storage and/or application after the potatoes are in storage.

In another aspect the present invention provides a method for inhibiting tuber sprouting without necrosis or softening of the tuber wherein said method comprises applying an effective amount of acetolactate synthase inhibitor herbicide formulation according to the present invention.

In an embodiment the invention provides a method for inhibiting the sprouting of tubers under storage using acetolactate synthase inhibitor herbicide formulation.

In an embodiment the invention provides a method for inhibiting tuber sprouting which also prevents or controls fungal growth upon the tubers, thereby reducing postharvest decay losses.

In a preferred embodiment the method will be carried out in a storage chamber. The storage chamber is preferably designed to store tubers, preferably potatoes, in a way to control the environment and will preferably only house tubers, preferably only potatoes. Preferably, the storage chambers are equipped with a temperature control system and even more preferably a humidity control system.

In a preferred embodiment the tubers to be treated are potatoes. Preferably the potatoes are destined to be sold on the fresh market.

In a further aspect, the invention provides ALS inhibitor treated tubers obtainable by a method according to the invention. There is no phytotoxicity observed on the tubers, also no internal sprouting and hence flavour of the tubers may not be influenced by this treatment.

In an embodiment the method of inhibiting the sprouting of stored tubers, especially potatoes, by applying ALS inhibitor as first sprout inhibiting agent to the stored potatoes and then applying a second sprout inhibiting agent other than ALS inhibitor at a later time.

In an embodiment the invention provides a method of treating potato tubers for inhibiting tuber sprouting in potatoes, the method comprises contacting the potato tuber with ALS inhibitor for a sufficient period.

In an embodiment the method for treatment of tubers comprising the steps of:

(a) providing a composition comprising acetolactate synthase herbicide (ALS inhibitor); and

(b) applying the composition onto said tubers

In preferred embodiment the method comprises applying composition by spraying or fogging method.

In an embodiment the method of treating potato tubers comprises contacting the potato tuber with a composition comprising ALS inhibitor effective to inhibit sprouting of tuber.

In an embodiment the treatment of tubers with ALS inhibitor in combination with at least one another inhibitors may be carried out by any suitable method known to those of skill in the art. For example, at least one sprout inhibitor as described herein and at least one conventional another inhibitor may be mixed together into a single composition for delivery to the tubers. The two are then applied simultaneously, e.g. as a single tank mixture.

The application of the present sprout inhibitor (including any mixture with another sprout inhibitor) may be carried out only once (i.e. early in the storage of the potatoes and even prior to tuber sprouting or at end of dormancy when sprouts 2-3 mm) for effective inhibition of the tuber sprout. Alternatively, depending on the factors such as the cultivar, the time of harvest of the potatoes, during the harvest, the length of storage of the potatoes, the intended use of the potatoes, etc. multiple applications of the compounds may be made.

The amount of sprout inhibitor according to the present invention which is applied is sufficient for effective termination, slow, prevention, and/or inhibition of sprout growth on the potato tubers.

The development of sprouts may thus be prevented altogether, or the onset of sprouting may be delayed, or existing sprouts may be killed, or the development of sprouts may be slowed compared to untreated tubers, etc. According to the present invention the process of sprouting is, in general, inhibited by treating the potato tubers with the ALS inhibitor as described herein, or its combination with at least one another sprout inhibitor.

In further aspect the present invention provides a method for inhibiting sprouting of potato tubers, comprising contacting a potato tuber with an amount of at least one acetolactate synthase inhibitor herbicide selected from imidazolinones, pyrimidinylthiobenzoates, sulfonylamino carbonyl triazolinones, sulfonylureas, and triazolopyrimidines, in amounts effective to inhibit sprouting.

In an embodiment the method for inhibiting sprouting of potato tubers comprises contacting a potato tuber with an amount of imidazolinones effective to inhibit sprouting.

In an embodiment the method for inhibiting sprouting of potato tubers comprises contacting a potato tuber with an amount of imazamox sufficiently effective to inhibit sprouting.

In an embodiment, the method for inhibiting sprouting of potato tubers comprises applying an acetolactate synthase inhibitor herbicide in an effective amount to inhibit the sprout after harvest.

In an embodiment, the method for inhibiting sprouting of potato tubers comprises applying an acetolactate synthase inhibitor herbicide in an effective amount to inhibit the sprout during storage.

In an aspect the present invention provides a potato tuber comprising, on at least a part of a surface thereof, at least one acetolactate synthase inhibitor herbicide.

In an embodiment the tuber comprising, on at least at least a part of a surface thereof, an acetolactate synthase inhibitor, and a second sprout inhibitor.

In an aspect the present invention provides use of ALS inhibitor to the suppression of sprouting during potato preservation/storage.

In preferred embodiment the present invention provides use of imazamox as sprout inhibitor.

In another preferred embodiment the present invention provides use of imazamox as sprout inhibitor for suppression of sprout in potato.

In an aspect the present invention provides an apparatus arranged to contact a potato tuber with a sprout inhibitor, said apparatus comprising therein an acetolactate synthase inhibitor herbicide.

### EXAMPLES

The advantages and other parameters of the present invention is illustrated by the below given examples. However, the scope of the present invention is not limited by the examples in any manner. While the present invention has been described in terms of its specific embodiments, certain modifications and equivalents will be apparent to those skilled in the art and are intended to be included within the scope of the present invention.

### Example 1

### Concentrated Imazamox Composition (SL Formulation)

A concentrated imazamox composition having the composition as shown below was prepared.

| Ingredients | g/L |
|---|---|
| Imazamox | 40 |
| Ethoxy sorbitan monolaurate | 350 |
| Propylene glycol | 150 |
| buffer | 15 |
| water | Q.S. |
| Total | 1000 |

The measured amount of imazamox was added into distilled water and mixed for 15 minutes.

Remaining ingredients were then added to above solution and stirred for 20 minutes. The solution was filtered and packed.

The concentrated imazamox composition was diluted in an aqueous liquid, in particular water, to form a diluted liquid composition, which is to be applied as a spray onto potatoes.

### Example 2

### Field Trial

The efficacy of sprout inhibitor for sprout suppression in storage potatoes was evaluated by applying the composition of present invention on potatoes on a conveyor belt. The treatment application for trial is at crop storage majority treatment 1) Beginning of sprouting: sprouts visible (<1 mm) and, treatment 2) at end of dormancy (sprouts 2-3 mm). After completion of the test, the potatoes were evaluated on sprouting reduction efficiency. No phytotoxicity was observed.

TABLE 1
Treatment (1): Beginning of sprouting:

| Trial | | | Rate | Tuber | Sprout | Sprouted |
|---|---|---|---|---|---|---|
| No. | Treatment | Rate | Unit | No. | No. | (%) |
| 1 | Untreated (Control) | | | 37.7 | 14.3 | 38.03 |
| 2 | Imazamox | 400 | ml/1000 kg | 39.7 | 9.7 | 24.77 |
| 3 | 1,4-Dimethylnaphthalene | 60 | ml/1000 kg | 36.7 | 15.7 | 42.80 |
| 4 | Carvone | 300 | ml/1000 kg | 38.7 | 12.3 | 32.02 |
| 5 | 3-Decen-2-One | 195 | ml/1000 kg | 35.3 | 9.0 | 24.75 |
| 6 | Maleic Hydrazide | 350 | ml/1000 kg | 41.3 | 8.0 | 19.28 |
| 7 | 2,4-D | 400 | ml/1000 kg | 40.0 | 12.3 | 31.14 |
| 8 | Chlorpropham | 75 | ml/1000 kg | 41.7 | 1.7 | 4.01 |

TABLE 2
Treatment (2): At end of dormancy

| | | Tuber | Sprout | Sprouted |
|---|---|---|---|---|
| Trial No. | Treatment | Number | Number | (%) |
| 1 | Untreated (Control) | 36.0 | 35.0 | 97.37 |
| 2 | Imazamox | 39.0 | 16.7 | 42.54 |
| 3 | 1,4-Dimethylnaphthalene | 36.3 | 34.3 | 94.59 |
| 4 | Carvone | 35.3 | 34.0 | 96.02 |
| 5 | 3-Decen-2-One | 32.7 | 32.7 | 100.0 |
| 6 | Maleic Hydrazide | 38.7 | 18.0 | 47.49 |
| 7 | 2,4-D | 39.0 | 38.7 | 99.21 |
| 8 | Chlorpropham | 40.0 | 16.0 | 38.26 |

### Example 3

Field trials were conducted in Belgium, during 2018 and 2019, in the potato crop. The potatoes of the variety Fontane and Innovator was used for anti-sprout treatment (Variety for processing) came up directly from the field (Harvested on Oct. 5, 2018 and Sep. 19, 2018).

The trial was set up in randomized complete block with single control randomized in each block under commercial storage practice. Potatoes treated 3 days after lifting and skin maturity was good. For application of formulation (carrier: 200 ml water for one treatment) container with rack and spray stick was used.

### Application Timing

The first application (A) was carried out Potatoes treated 3 days after lifting. The following applications were carried out at four weeks' interval for each treatment.

(A): right after harvest, before putting into storage.

Storage conditions: The trials are stored in shed at temperature 5-18° C. and all plots of a trial should be stored in the same place.

TABLE 3

| | | | | Tuber | Sprout | Sprout |
|---|---|---|---|---|---|---|
| | | | | SPROUTED | weight | LENMAX |
| Sr. | | | | (%) after | after | after |
| No. | Treatment | Rate | Rate unit | 55 DA | 55 DA | 55 DA |
| 1 | Untreated | — | — | 94.82 | 11.07 | 3.3 |
| | Check | | | | | |
| 3 | Imazamox | 24 | g ai/1000 kg | 75.26 | 4.2 | 1.2 |
| 4 | Imazamox | 30 | g ai/1000 kg | 71.68 | 4.13 | 1.7 |
| 5 | Imazamox | 12 | g ai/1000 kg | 78.67 | 6.89 | 1.5 |
| 6 | Imazamox | 18 | g ai/1000 kg | 73.21 | 4.09 | 1.7 |
| 8 | Maleic | 54 | g ai/1000 kg | 93.97 | 10 | 2.8 |
| | hydrazide | | | | | |
| 9 | Maleic | 94.5 | g ai/1000 kg | 96.59 | 13.87 | 2.8 |
| | hydrazide | | | | | |
| 10 | Maleic | 54 | g ai/1000 kg | 93.33 | 12.08 | 2.8 |
| | hydrazide | | | | | |
| 11 | Maleic | 94.5 | g ai/1000 kg | 92.93 | 9.13 | 2.7 |
| | hydrazide | | | | | |

Rating Type:
SPROUTED = Sprouted tubers
LENMAX = Length maximal

It can be seen from Table 3 that the imazamox treatments are effective for inhibition of sprouts. There is reduction in number of sprouted tubers according to number of sprout tuber assessment as compared to the untreated treatment. Further it was observed from the above table that Maleic hydrazide (94.5 g a.i.) all or almost all tubers are sprouted whereas in treatments 2 to 7 reduction in tuber sprout was seen. In term of sprout weight, an advantage was found for all treatments with imazamox as compared to maleic hydrazide. In terms of phytotoxicity, all treatments of this protocol proved to be perfectly selective with regards to the tubers (no phytotoxicity symptoms detected). Therefore, this is an important and surprising finding because this data shows that the compositions used in accordance with the present invention can use imazamox a sprout inhibitor to achieve good control of sprout in potato. It can be concluded from this data that the imazamox-containing compositions (treatment 2 and 7) provide efficacious sprout inhibiting effect.

Preferably for better effect the treatment of tuber sprouts can be continued i.e. the spray treatment should be repeated within a period of from 2 to 8 months from the first spray treatment. The following treatments and the results are summarised in Tables 4 and 5 as below.

TABLE 4

| | | | | Tuber | Tuber | Sprout | Sprout | Sprout | Sprout |
|---|---|---|---|---|---|---|---|---|---|
| Sr. | | | Rate | sprout | sprout | weight | weight | Lenmax | Lenmax |
| No. | Treatment | Rate | unit | % 55 DA | % 116 DA | 55 DA | 116 DA | 55 DA | 116 DA |
| 1 | Untreated | | | 94.82 | 100 | 11.07 | 53.29 | 3.3 | 7.7 |
| | Check | | | | | | | | |
| 5 | Imazamox | 200 | ml/1000 kg | 75.26 | 81.59 | 4.2 | 7.07 | 1.2 | 2 |
| 6 | Imazamox | 250 | ml/1000 kg | 71.68 | 71.93 | 4.13 | 4.92 | 1.7 | 1.3 |
| 7 | Imazamox | 100 | ml/1000 kg | 78.67 | 85.86 | 6.89 | 12.31 | 1.5 | 3.3 |
| 8 | Imazamox | 150 | ml/1000 kg | 73.21 | 79.15 | 4.09 | 7.92 | 1.7 | 2.8 |
| 10 | Maleic | 270 | ml/1000 kg | 93.97 | 96.43 | 10 | 28.73 | 2.8 | 5.7 |
| | hydrazide | | | | | | | | |
| 11 | Maleic | 473 | ml/1000 kg | 96.59 | 99.19 | 13.87 | 26.09 | 2.8 | 3.8 |
| | hydrazide | | | | | | | | |
| 12 | Maleic | 270 | ml/1000 kg | 93.33 | 98.72 | 12.08 | 31.9 | 2.8 | 5.7 |
| | hydrazide | | | | | | | | |
| 13 | Maleic | 473 | ml/1000 kg | 92.93 | 98.45 | 9.13 | 23.37 | 2.7 | 4.7 |
| | hydrazide | | | | | | | | |
| 14 | Chorpropharm | 75 | ml/1000 kg | 13.25 | 30.11 | 0.8 | 15.87 | 1.3 | 6 |
| 14 | Chorpropharm | 150 | ml/1000 kg | 2.85 | 9.78 | 0.08 | 2.24 | 0.5 | 3 |

TABLE 5

| | | | | Tuber | Tuber | Sprout | Sprout | Tuber | Tuber | Sprout | Sprout |
|---|---|---|---|---|---|---|---|---|---|---|---|
| Sr | | | Rate | sprouted | sprouted | weight | weight | sprate | sprate | lenmax | lenmax |
| no. | Treatment | Rate | unit | (%) 126 DA | % 182 DA | 126 DA | 182 DA | 126 da-a | 182 da-a | 126 DA-A | 182 DA-A |
| 1 | Untreated | — | — | 100 | 100 | 35.22 | 314.3 | 5.83 | 0.67 | 7.7 | 18 |
| | Check | | | | | | | | | | |
| 2 | Imazamox | 50 | ml/1000 kg | 88.47 | 88.1 | 6.54 | 23 | 8.83 | 8.67 | 3.7 | 4.2 |
| 3 | Imazamox | 100 | ml/1000 kg | 80.74 | 86.19 | 8.31 | 23.9 | 8.83 | 8.83 | 5.2 | 4 |
| 4 | Imazamox | 150 | ml/1000 kg | 81.43 | 73.1 | 2.23 | 3.77 | 9.5 | 9.75 | 1.7 | 1 |
| 5 | Imazamox | 200 | ml/1000 kg | 73.58 | 77.93 | 1.93 | 5.77 | 9.67 | 9.58 | 2.2 | 1.7 |
| 6 | Imazamox | 250 | ml/1000 kg | 75.06 | 74.98 | 1.65 | 3.53 | 9.75 | 9.67 | 0.9 | 1.2 |
| 7 | Imazamox | 100 | ml/1000 kg | 80.08 | 83.33 | 3.31 | 4.7 | 9.5 | 9.67 | 2.8 | 1.3 |
| 8 | Imazamox | 150 | ml/1000 kg | 72.58 | 75.45 | 1.83 | 3.13 | 9.58 | 9.75 | 1.7 | 0.7 |
| 9 | Imazamox | 200 | ml/1000 kg | 75.44 | 65.99 | 1.75 | 3.3 | 9.75 | 9.67 | 2.1 | 1 |
| 10 | Maleic | 270 | ml/1000 kg | 91.88 | 100 | 22.97 | 116.87 | 6.92 | 6.08 | 6.8 | 7.3 |
| | hydrazide | | | | | | | | | | |
| 11 | Maleic | 472.5 | ml/1000 kg | 90.94 | 97.98 | 15.56 | 57.23 | 7.75 | 7.83 | 4.8 | 4.8 |
| | hydrazide | | | | | | | | | | |
| 12 | Maleic | 270 | ml/1000 kg | 95.66 | 100 | 20.94 | 115.77 | 7.17 | 6.08 | 5.7 | 9 |
| | hydrazide | | | | | | | | | | |
| 13 | Maleic | 472.5 | ml/1000 kg | 93.27 | 100 | 17.66 | 113.1 | 7.67 | 6.17 | 5.5 | 8.5 |
| | hydrazide | | | | | | | | | | |
| 14 | Chorpropharm | 75 | ml/1000 kg | 97.7 | 100 | 28.79 | 317.57 | 6.25 | 0 | 7.7 | 20 |
| 15 | Chorpropharm | 150 | ml/1000 kg | 72.55 | 100 | 15.44 | 199.22 | 7.67 | 3.25 | 5.7 | 16.7 |

It can be seen from above table that at dose rate of 250 ml/1000 kg of the composition of imazomox 74% of the tubers germinated which is comparable from the dose rate of 472.5 ml/1000 kg of maleic hydrazide showing 97% of the tubers sprouted. It was surprising effect for chlorprofharm which showed 100% tubers sprouted.

In conclusions, it is demonstrated that the treatments with present composition comprising imazamox surprisingly provided effective sprout control over an extended period of time as compared to other treatments such as maleic hydrazide, CIPC etc. and represent effective sprout suppression in potato at storage or in store application.

1.) A composition for tuber sprout inhibition, said composition comprising an acetolactate synthase (ALS) compound.

2.) The composition according to claim 1, wherein said acetolactate synthase compound is selected from imidazolinones, pyrimidinylthiobenzoates, sulfonylamino carbonyl triazolinones, ureas preferably sulfonylureas, pyrazole, triazolones, triazolopyrimidines and combinations thereof.

3.) The composition according to claim 2, wherein said acetolactate synthase compound is an imidazolinone compound selected from imazamethabenz, imazamox, imazapic, imazaquin, amzethapyr, imazapyr, and combinations thereof.

4.) The composition according to claim 2, wherein said imidazolinone compound is amazamox.

5.) The composition according to claim 1, in the form of a liquid composition.

6.) The composition according to claim 5, wherein said liquid composition is soluble concentrate (SL).

7.) The composition according to claim 5, wherein the composition is an aqueous liquid composition.

8.) The composition according to claim 1, further comprising a second sprout inhibitor.

9.) The composition according to claim 1, further comprising at least one agrochemically acceptable carrier.

10.) The composition according to claim 9, wherein said agrochemically acceptable carrier comprises a surfactant, a filler, a crystallization inhibitor, a viscosity modifier, a solvent, a suspending agent, a spray droplet modifier, a pigment, an antioxidant, a foaming agent, a compatibilizing agent, an antifoam agent, a sequestering agent, a neutralizing agent, a buffer, a spreading agent, an emollient, a dispersing agent, a thickening agent, an antimicrobial agent, or a combination thereof.

11.) A method for inhibiting sprouting of tubers, said method comprising treating the tuber under pre-storage or storage condition with imazamox.

12.) A method for treatment of tubers comprising the steps of:
a. providing a composition comprising an acetolactate synthase herbicide; and
b. applying the composition onto said tubers.

13.) The method as claimed in claim 12, wherein applying is by spraying or fogging method.

14.) The method according to claim 12, comprising diluting the composition by mixing the composition with an aqueous liquid prior to applying.

15.) The method according to claim 12, wherein the composition comprises about 100 to 250 grams/liter of imazamox as the acetolactate synthase herbicide.

16.) The method according to claim 12, wherein spraying is repeated within a period of from 2 to 8 months from the first spray treatment.

17.) (canceled)

18.) (canceled)

19.) (canceled)

20.) (canceled)

21.) (canceled)
